(19) United States
(12) Patent Application Publication
(10) Pub. No.: US 2019/0030586 A1
(43) Pub. Date: Jan. 31, 2019

(54) METHOD OF MANUFACTURING SKELETON MEMBER FOR VEHICLE

(71) Applicants: AISIN SEIKI KABUSHIKI KAISHA, Kariya-shi, Aichi-ken (JP); AISIN TAKAOKA CO., LTD., Toyota-shi, Aichi-ken (JP); AISIN KEIKINZOKU KABUSHIKI KAISHA, Imizu-shi, Toyama-ken (JP)

(72) Inventors: Kohei HODOYA, Kariya-shi (JP); Kiyohito KONDO, Aichi-gun (JP); Yuki ISHIGURO, Chiryu-shi (JP); Takeki MATSUMOTO, Okazaki-shi (JP); Tomoo YOSHIDA, Toyama-shi (JP); Tamaki OBAYASHI, Toyama-shi (JP)

(73) Assignees: AISIN SEIKI KABUSHIKI KAISHA, Kariya-shi, Aichi-ken (JP); AISIN TAKAOKA CO., LTD., Toyota-shi, Aichi-ken (JP); AISIN KEIKINZOKU KABUSHIKI KAISHA, Imizu-shi, Toyama-ken (JP)

(21) Appl. No.: 16/072,735

(22) PCT Filed: May 12, 2016
(86) PCT No.: PCT/JP2016/064161

§ 371 Date: Jul. 25, 2018

(30) Foreign Application Priority Data
Jan. 29, 2016 (JP) 2016-015020

(51) Int. Cl. B21D 47/01; B21C 23/08; B21D 22/02

(52) U.S. Cl. CPC B21D 47/01; B60J 5/0443; B21D 22/02; B21C 23/08

(57) ABSTRACT

Provided is a method of manufacturing a vehicle skeleton member, the skeleton member including one or more groove-shaped portions extending in a predetermined direction, the method including an extrusion step and a press-working step. In the extrusion step, a sheet-shaped member including one or more first sheet-shaped portions each having a band-like shape, which extend in the predetermined direction, and second sheet-shaped portions each having a band-like shape, which extend in the predetermined direction along end portions of the first sheet-shaped portion in a width direction of the first sheet-shaped member and each have a sheet thickness smaller than a sheet thickness of the first sheet-shaped portion, is manufactured by using an extrusion molding method. In the press-working step, the sheet-shaped member is pressed so that at least part of a bottom wall portion of the groove-shaped portion is formed of the first sheet-shaped portion and side wall portions of the groove-shaped portion are formed of the second sheet-shaped portions, respectively.

### TECHNICAL FIELD

The present invention relates to a method of manufacturing a vehicle skeleton member.

### BACKGROUND ART

As described in Patent Literatures 1, 2, and 3, there is known a vehicle door impact beam to be mounted inside a vehicle door as one of vehicle skeleton members. The vehicle door impact beam is configured to absorb an impact exerted on the vehicle door to prevent a large deformation of the vehicle door when an object collides against the vehicle door.

Each of the vehicle door impact beams described in Patent Literature 1 and Patent Literature 2 is formed into a cylindrical shape. Specifically, each of the above-mentioned vehicle door impact beams includes an inner wall portion arranged on an inner panel side of the vehicle door, and an outer wall portion arranged on an outer panel side of the vehicle door. The inner wall portion and the outer wall portion are provided to extend in parallel to each other and are opposed to each other. Further, each of the above-mentioned vehicle door impact beams includes a pair of side wall portions that is formed between the inner wall portion and the outer wall portion to connect the inner wall portion and the outer wall portion to each other. In other words, each of the above-mentioned vehicle door impact beams has a hollow portion surrounded by the inner wall portion, the outer wall portion, and the side wall portions described above. The above-mentioned vehicle door impact beams are each made of an aluminum alloy and manufactured by using an extrusion molding method.

Further, the vehicle door impact beam described in Patent Literature 3 is provided to extend in a predetermined direction and is formed to have a groove-like shape that is open toward the inner panel side (see FIG. 3(b) of Patent Literature 3). Specifically, the vehicle door impact beam includes a bottom wall portion that forms a bottom portion of the groove, and side wall portions that form side portions of the groove. The side wall portions are connected to both ends of the bottom wall portion in a width direction and are opposed to each other. A flange portion that extends to an outside of the groove (outside of a space surrounded by the bottom wall portion and the side wall portions) is formed at an inner panel-side end of each of the side wall portions. A recessed portion (groove portion) extending in a longitudinal direction of the bottom wall portion is formed in an outer panel-side surface of the bottom wall portion. Specifically, the recessed portion is open toward the outer panel side (see FIG. 3(a) of Patent Literature 3). The vehicle door impact beam is manufactured by press-forming a metal steel sheet having a band-like shape.

### CITATION LIST

### Patent Literature

[PTL 1] JP 11-48779 A

[PTL 2] JP 2001-301462 A

[PTL 3] JP 2010-195187 A

### SUMMARY OF INVENTION

### Technical Problem

In general, a space inside the vehicle door is small. In particular, a dimension of the space in a vehicle width direction at positions, at which a front end portion and a rear end portion of the vehicle door impact beam (specifically, a front end portion and a rear end portion of the vehicle door) are arranged, is small. Therefore, in a case in which the vehicle door impact beam is manufactured by using the extrusion molding method as in the cases of Patent Literature 1 and Patent Literature 2, when a dimension of the vehicle door impact beam in the vehicle width direction is set small in accordance with the dimension of the space of the vehicle door at the front end portion and the rear end portion in the vehicle width direction, a thickness of each of the wall portions of the vehicle door impact beam is required to be increased so as to ensure a sufficient strength of the vehicle door impact beam. Therefore, a weight of the vehicle door impact beam becomes relatively large.

Meanwhile, a dimension of a portion of the space in the vehicle width direction inside the vehicle door in which a portion including an intermediate portion and a vicinity of the intermediate portion of the vehicle door impact beam is arranged is larger than the dimension of the space in the vehicle width direction at the positions at which the front end portion and the rear end portion of the vehicle door impact beam are arranged. Therefore, the following manufacturing method is conceivable. First, a linearly extending semifinished member is manufactured by the extrusion molding method. A dimension of the semifinished member in the vehicle width direction is larger than the dimension of the space in the vehicle width direction at the front end portion and the rear end portion of the vehicle door. Then, by compressing (press-forming) a front end portion and a rear end portion of the semifinished member in the vehicle width direction, the dimension of each of the front end portion and the rear end portion in the vehicle width direction is reduced. In this manner, the dimension of each of the front end portion and the rear end portion of the vehicle door impact beam in the vehicle width direction can be reduced to be smaller than the dimension of the intermediate portion in the vehicle width direction. In a case in which the front end portion and the rear end portion of the semifinished member cannot be compressed by a large amount, brackets are required to be respectively mounted to the front end portion and the rear end portion of the vehicle door impact beam so that the vehicle door impact beam is mounted to the vehicle door through intermediation of the brackets.

Further, a sheet thickness of each of the portions of the vehicle door impact beam described in Patent Literature 3 on a cross section perpendicular to a longitudinal direction of the vehicle door impact beam is constant. Specifically, the sheet thickness of a portion that little affects the strength of the vehicle door impact beam (for example, the side wall portions of the groove) is unnecessarily large. Therefore, the vehicle door impact beam is heavy.

The present invention has been made to cope with the problems described above, and has an object to provide a vehicle skeleton member, which has a high flexural rigidity and a small weight. Note that, in the following description of components of the present invention, for ease of understanding of the present invention, reference symbols corresponding to components according to embodiments of the present invention are described in parentheses. However, the components of the present invention should not be construed as being limited to the corresponding components denoted by the reference symbols of the embodiments.

In order to achieve the above-mentioned object, as one feature of the present invention, provided is a method of manufacturing a vehicle skeleton member (10, 20, 50), the skeleton member including one or more groove-shaped portions extending in a predetermined direction, the method including:

an extrusion step of manufacturing, by using an extrusion molding method, a sheet-shaped member (BM1, BM2, BM3, BM4, BP) including one or more first sheet-shaped portions (111a, 121a, 211a, 221a, 311a, 411a, Pa) each having a band-like shape and extending in the predetermined direction, and second sheet-shaped portions (112a, 113a, 122a, 123a, 212a, 213a, 222a, 223a, 312a, 313a, 412a, 413a, B1, B2, B3) each having a band-like shape and extending in the predetermined direction along end portions of the first sheet-shaped portion in a width direction of the first sheet-shaped member, and each having a sheet thickness smaller than a sheet thickness of the first sheet-shaped portion; and

a press-working step of pressing the sheet-shaped member so that at least part of a bottom wall portion (111, 121, 211, 221, 311, 411, 511) of the groove-shaped portion is formed of the first sheet-shaped portion and side wall portions (112, 113, 122, 123, 222, 223, 312, 313, 412, 413, 512, 513) of the groove-shaped portion are formed of the second sheet-shaped portions, respectively. In the present invention, the term “vehicle skeleton member” means, for example, a skeleton member such as a vehicle main body and a door and a reinforcing member as illustrated in FIG. 27.

In this case, in the press-working step, the sheet-shaped member may be pressed so that at least a boundary portion between the bottom wall portion and each of the side wall portions of the groove-shaped portion is formed of the first sheet-shaped portion and the side wall portions of the groove-shaped portion are formed of the second sheet-shaped portions, respectively.

Further, in this case, in the press-working step, the sheet-shaped member may be pressed by using a die quenching method.

The sheet-shaped member does not have a closed space. Hence, a material can be more easily extruded through a die than in a case in which a cylindrical member such as the vehicle door impact beams described in Patent Literature 1 and Patent Literature 2 is manufactured. Therefore, a material having a higher strength than strengths of materials for the related art can be used. For example, for related-art vehicle skeleton members, an aluminum alloy material having a tensile strength of about 400 MPa is adopted. On the other hand, for the vehicle skeleton member according to one embodiment of the present invention, an aluminum alloy material having a tensile strength of about 500 MPa can be adopted.

Further, in the vehicle skeleton member according to one embodiment of the present invention, at least part of the bottom wall portion of the groove-shaped portion is formed of the first sheet-shaped portion, and the side wall portions of the groove-shaped portion are formed of the second sheet-shaped portions, respectively. Specifically, a thickness of the at least part of the bottom wall portion of the groove-shaped portion, which has a large effect on the flexural rigidity, is set larger than a thickness of each of the side wall portions of the groove-shaped portion, which have a small effect on the flexural rigidity. In this manner, the flexural rigidity can be kept high, and the vehicle skeleton member can be reduced in weight at the same time.

Further, as another feature of the present invention, provided is a method of manufacturing a vehicle skeleton member, in which one side surfaces of two of the second sheet-shaped members respectively located on both sides of the first sheet-shaped portion, which form part of one side surface of the sheet-shaped member, are continuous with one side surface of the first sheet-shaped member, which forms part of the one side surface of the sheet-shaped member, and, in which, in the press-working step, the sheet-shaped member is pressed so that the one side surface of the first sheet-shaped portion and the one side surfaces of the two second sheet-shaped portions form an inner surface of the groove-shaped portion.

In this case, each end portion of the sheet-shaped member in the width direction of the sheet-shaped member may be formed of the first sheet-shaped portion, that in the press-working step, the sheet-shaped member be processed with use of a die formed of an upper die and a lower die, and that a gap (t) between the upper die and the lower die when the die is in a closed state be set equal to the sheet thickness of the first sheet-shaped portion.

With the above-mentioned configuration, the one side surface of the first sheet-shaped portion and the one side surfaces of the second sheet-shaped portions are continuous without formation of a level difference at boundary portions between the one side surface of the first sheet-shaped portion and the one side surfaces of the second sheet-shaped portions. The sheet-shaped member is pressed so that the one side surface of the first sheet-shaped portion and the one side surfaces of the second sheet-shaped portions form an inner surface of the groove-shaped portion. Therefore, a largely bent portion is not formed at boundaries between the bottom wall portion and the side wall portions. Therefore, the strength of the vehicle door impact beam can be increased to be higher than the strengths of the related-art vehicle door impact beams.

### BRIEF DESCRIPTION OF DRAWINGS

FIG. 1 is a schematic view of a vehicle to which a vehicle door impact beam according to a first embodiment is applied.

FIG. 2 is a sectional view for illustrating a cross section of a door of FIG. 1, which is perpendicular to a vehicle height direction.

FIG. 3 is a perspective view of the vehicle door impact beam of FIG. 1.

FIG. 4 is an enlarged view for illustrating an inside of the door of FIG. 1 in an enlarged manner.

FIG. 5 is a sectional view taken along the arrow A-A of FIG. 4.

FIG. 6 is a sectional view taken along the arrow B-B of FIG. 4.

FIG. 7 is a perspective view of a sheet-shaped member according to the first embodiment.

FIG. 8 is an enlarged view of a boundary portion between a connection wall portion and a side wall portion.

FIG. 9 is a perspective view of a vehicle door impact beam according to another example.

FIG. 10 is a sectional view for illustrating a cross section of an intermediate portion of the vehicle door impact beam of FIG. 8, which is perpendicular to a beam longitudinal direction.

FIG. 11 is a sectional view for illustrating a cross section of a front end portion (rear end portion) of the vehicle door impact beam of FIG. 8, which is perpendicular to the beam longitudinal direction.

FIG. 12 is a schematic view of a die to be used to press the sheet-shaped member of FIG. 7.

FIG. 13 is a schematic view for illustrating a step of pressing the sheet-shaped member of FIG. 7.

FIG. 14 is a sectional view for illustrating another example of the front end portion (rear end portion) of the vehicle door impact beam.

FIG. 15 is a sectional view for illustrating another example of the cross section of the intermediate portion of the vehicle door impact beam, which is perpendicular to the beam longitudinal direction.

FIG. 16 is a schematic view for illustrating a step of pressing the sheet-shaped member of FIG. 7 or FIG. 11.

FIG. 17 is a sectional view for illustrating a cross section of an intermediate portion of a vehicle door impact beam according to a modification example of the first embodiment, which is perpendicular to the beam longitudinal direction.

FIG. 18 is a sectional view for illustrating a cross section of a front end portion (rear end portion) of the vehicle door impact beam of FIG. 17, which is perpendicular to the beam longitudinal direction.

FIG. 19 is a sectional view for illustrating a cross section of an intermediate portion of a vehicle door impact beam according to another modification example of the first embodiment, which is perpendicular to the beam longitudinal direction.

FIG. 20 is a sectional view for illustrating a cross section of a front end portion (rear end portion) of the vehicle door impact beam of FIG. 19, which is perpendicular to the beam longitudinal direction.

FIG. 21 is a schematic view of a center pillar according to a second embodiment.

FIG. 22A is a sectional view taken along the arrow A-A of FIG. 21.

FIG. 22B is a sectional view taken along the arrow B-B of FIG. 21.

FIG. 22C is a sectional view taken along the arrow C-C of FIG. 21.

FIG. 23 is a perspective view of a sheet-shaped member according to the second embodiment.

FIG. 24 is a plan view of the sheet-shaped member according to the second embodiment.

FIG. 25 is a perspective view of the center pillar according to a modification example of the second embodiment.

FIG. 26 is a sectional view of the center pillar according to another modification example of the second embodiment, for illustrating a cross section of an intermediate portion in the vehicle height direction, which is perpendicular to a longitudinal direction of the center pillar.

FIG. 27 is a schematic view for illustrating examples of a vehicle skeleton member to which the present invention is applicable.

### DESCRIPTION OF EMBODIMENTS

### First Embodiment

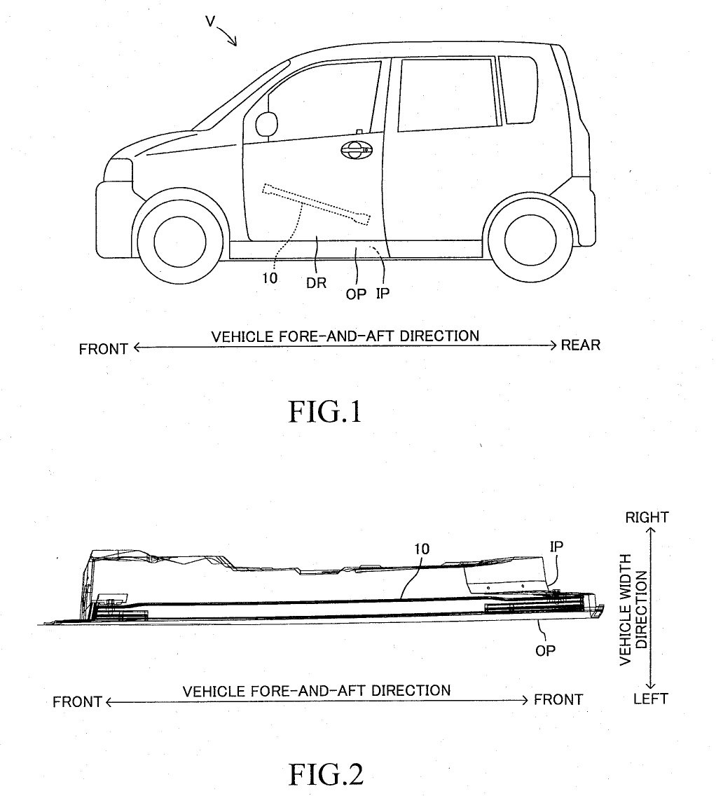

Now, a vehicle door impact beam 10 according to a first embodiment of the present invention is described. First, an outline of a vehicle V to which the vehicle door impact beam 10 is mounted is described. As illustrated in FIG. 1, a door DR is mounted to a frame (component constructing a frame of a vehicle cabin) of the vehicle V in an openable and closable manner. The vehicle door impact beam 10 according to the first embodiment is mounted inside the door DR. As is well known, the door DR includes an outer panel OP and an inner panel IP, and the vehicle door impact beam 10 is arranged between the outer panel OP and the inner panel IP. Inside the door DR, besides the vehicle door impact beam 10, for example, a door glass and a device configured to move the door glass up and down are arranged. Therefore, as illustrated in FIG. 2, a space in which the vehicle door impact beam 10 is arranged is small. In particular, the space (dimension in a vehicle width direction) is small at positions at which a front end portion and a rear end portion of the vehicle door impact beam 10 are located. Although an example in which the present invention is applied to the vehicle door impact beam 10 to be mounted in the left door DR of the vehicle V is described in the first embodiment, the present invention is also applicable to a vehicle door impact beam to be mounted in another door.

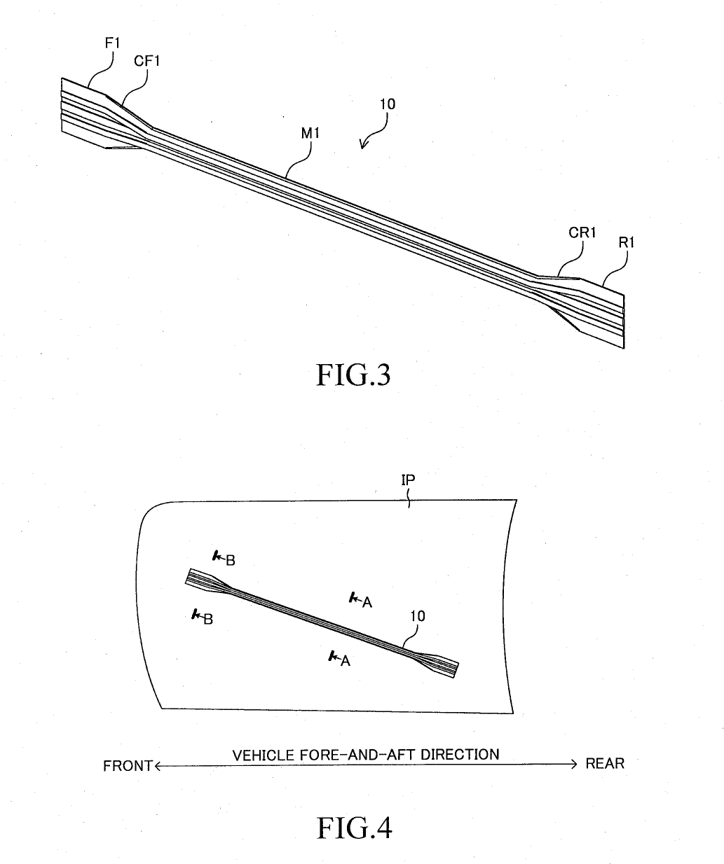

As illustrated in FIG. 3 and FIG. 4, the vehicle door impact beam 10 is formed into an elongate shape, and is arranged to extend from a rear end to a front end of the inner panel IP. The vehicle door impact beam 10 is fixed in an inclined posture to the inner panel IP so that a front end side of the vehicle door impact beam 10 is positioned above a rear end side thereof.

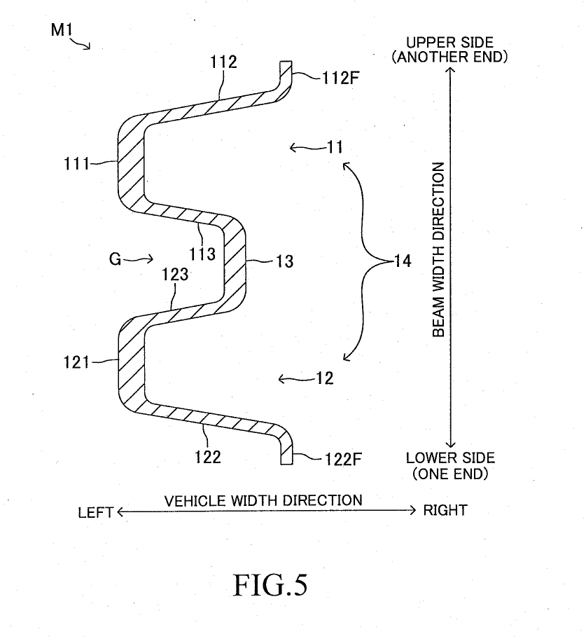

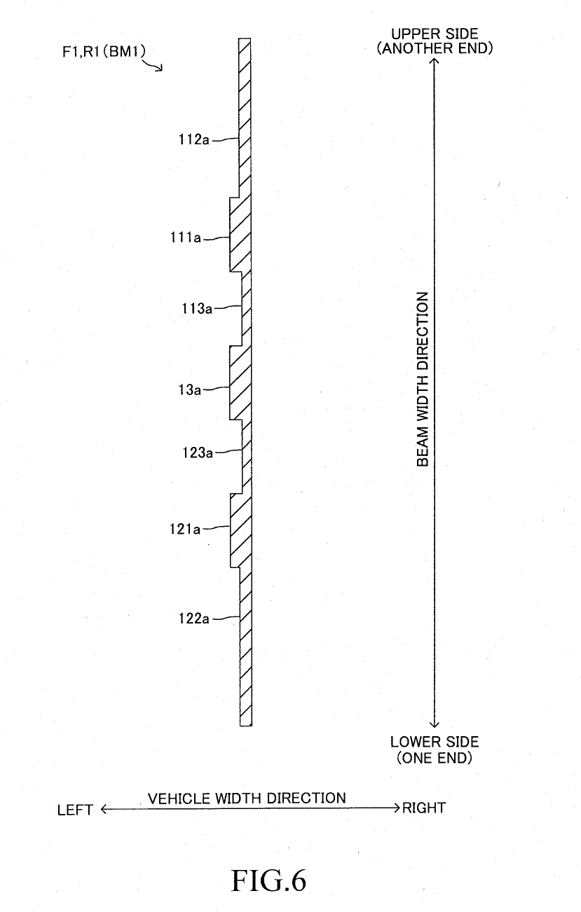

Now, a shape of the vehicle door impact beam 10 is described with reference to FIG. 5 and FIG. 6. FIG. 5 is an illustration of a cross section of an intermediate portion and FIG. 6 is an illustration of a cross section of end portions (front end portion and rear end portion) of the vehicle door impact beam 10 in a longitudinal direction of the vehicle door impact beam 10, each for illustrating a cross section perpendicular to the longitudinal direction of the vehicle door impact beam 10. A right-and-left direction of the drawing sheets of FIG. 5 and FIG. 6 corresponds to the vehicle width direction. As illustrated in FIG. 5 and FIG. 6, a vehicle inner side of the vehicle door impact beam 10 is defined as a right side. Further, a vehicle outer side of the vehicle door impact beam 10 is defined as a left side. Further, a direction perpendicular to the drawing sheets of FIG. 5 and FIG. 6 is defined as a beam longitudinal direction. The beam longitudinal direction is orthogonal to the vehicle width direction. Further, an up-and-down direction of the drawing sheets of FIG. 5 and FIG. 6, that is, a direction orthogonal to both the beam longitudinal direction and the vehicle width direction is defined as a beam width direction. One end side of the vehicle door impact beam 10 in the beam width direction is defined as a lower side. Further, another end side of the vehicle door impact beam 10 in the beam width direction is defined as an upper side.

As illustrated in FIG. 5, an intermediate portion M1 of the vehicle door impact beam 10 in the beam longitudinal direction has an open cross section. Specifically, the intermediate portion M1 is formed so as not to form a closed internal space. The intermediate portion M1 has a groove-shaped portion 14 including a first groove portion 11 and a second groove portion 12 each extending in the beam longitudinal direction and being open toward the right side. Specifically, a groove depth direction of the first groove portion 11 and the second groove portion 12 matches the vehicle width direction.

The first groove portion 11 has a bottom wall portion 111 and side wall portions 112 and 113. The bottom wall portion 111 is formed into a sheet-like shape extending in the beam longitudinal direction. A sheet thickness direction of the bottom wall portion 111 matches the vehicle width direction. Further, a width direction of the bottom wall portion 111 (direction perpendicular to a longitudinal direction and the sheet thickness direction of the bottom wall portion 111) matches the beam width direction. The side wall portions 112 and 113 extend from an upper end portion and a lower end portion of the bottom wall portion 111 in the width direction to the right side (vehicle cabin side), respectively, and are each formed into a sheet-like shape extending in the beam longitudinal direction. A sheet thickness direction of each of the side wall portions 112 and 113 is slightly inclined with respect to the beam width direction. Specifically, a right end portion of the side wall portion 112 is located slightly above a left end portion thereof. Further, a right end portion of the side wall portion 113 is located slightly below a left end portion thereof. The side wall portion 112 has a flange portion 112F. The flange portion 112F is located at the right end of the side wall portion 112. The flange portion 112F projects upward (to the outside of the groove (space surrounded by the bottom, wall portion 111 and the side wall portions 112 and 113)) and is formed to extend in the beam longitudinal direction.

The second groove portion 12 is formed below the first groove portion 11 to extend in parallel to the first groove portion 11. A position of the first groove portion 11 and a position of the second groove portion 12 are the same in the vehicle width direction. The second groove portion 12 has a bottom wall portion 121 and side wall portions 122 and 123 similar to the, bottom wall portion and the side wall portions of the first groove portion 11. Further, the side wall portion 122 has a flange portion 122F. The flange portion 122F is located at the right end of the side wall portion 122. The flange portion 122F projects downward (to the outside of the groove (space surrounded by the bottom wall portion 121 and the side wall portions 122 and 123)) and is formed to extend in the beam longitudinal direction.

The right end portion of the side wall portion 113 and a right end portion of the side wall portion 123 are in connection to each other through a connecting wall portion 13. The connecting wall portion 13 is formed into a sheet-like shape extending in the beam longitudinal direction. A sheet thickness direction of the connecting wall portion 13 matches the vehicle width direction. A groove portion G that extends in the longitudinal direction of the vehicle door impact beam 10 and is open toward the left side is formed by the side wall portion 113, the side wall portion 123, and the connecting wall portion 13.

A cross section of the intermediate portion M1, which is perpendicular to the longitudinal direction, is constant regardless of a cutting position as illustrated in FIG. 5. A dimension of the intermediate portion M1 in the beam longitudinal direction is, for example, 600 mm. A sheet thickness of each of the bottom wall portions 111 and 121 and the connecting wall portion 13 is larger than a sheet thickness of each of the side wall portions 112, 113, 122, and 123. The sheet thickness of each of the bottom wall portions 111 and 121 and the connecting wall portion 13 is, for example, 4.5 mm. Further, the sheet thickness of each of the side wall portions 112, 113, 122, and 123 is, for example, 2.5 mm.

As illustrated in FIG. 6, each of a front end portion F1 and a rear end portion R1 of the vehicle door impact beam 10 in the beam longitudinal direction is formed into a sheet-like shape. A configuration of the front end portion F1 and a configuration of the rear end portion R1 are the same. Therefore, only the configuration of the front end portion F1 is described below, and the description of the rear end portion R1 is herein omitted.

The front end portion F1 includes sheet-shaped portions 111a, 112a, 113a, 121a, 122a, 123a, and 13a each extending in the beam longitudinal direction. A sheet thickness direction of the sheet-shaped portions described above matches the vehicle width direction. A lower end of the sheet-shaped portion 112a is in connection to an upper end of the sheet-shaped portion 111a in the beam width direction. An upper end of the sheet-shaped portion 113a is in connection to a lower end portion of the sheet-shaped portion 111a. A lower end of the sheet-shaped portion 123a is in connection to an upper end of the sheet-shaped portion 121a in the beam width direction. An upper end of the sheet-shaped portion 122a is in connection to a lower end of the sheet-shaped portion 121a. A lower end of the sheet-shaped portion 113a is in connection to an upper end of the sheet-shaped portion 13a, and an upper end of the sheet-shaped portion 123a is in connection to a lower end of the sheet-shaped portion 13a. Right surfaces of the sheet-shaped portions are located in the same plane. A through hole (not shown) passing through the sheet-shaped portion 13a in the vehicle width direction is formed in the sheet-shaped portion 13a.

A cross section of the front end portion F1, which is perpendicular to the longitudinal direction, is constant regardless of a cutting position as illustrated in FIG. 6. A dimension of the front end portion F1 in the beam longitudinal direction is, for example, 100 mm. A sheet thickness of each of the sheet-shaped portions 111a, 121a, and 13a is larger than a sheet thickness of each of the sheet-shaped portions 112a, 113a, 122a, and 123a. The sheet thickness of each of the sheet-shaped portions 111a, 121a, and 13a is, for example, 4.5 mm. Further, the sheet thickness of each of the sheet-shaped portions 112a, 113a, 122a, and 123a is, for example, 2.5 mm.

As illustrated in FIG. 3, in the vehicle door impact beam 10, the intermediate portion M1 and the front end portion F1 are in connection to each other through a connecting portion CF1, and the intermediate portion M1 and the rear end portion R1 are in connection to each other through a connecting portion CR1. A configuration of the connecting portion CR1 is the same as a configuration of the connecting portion CF1. Therefore, only the configuration of the connecting portion CF1 is described below, and the description of the connecting portion CR1 is herein omitted.

A sectional shape of the connecting portion CF1, which is perpendicular to the beam longitudinal direction, gradually changes in a direction from a front end to a rear end of the connecting portion CF1. A sectional shape of the front end of the connecting portion CF1 is the same as a sectional shape of the front end portion F1, whereas a sectional shape of the rear end of the connecting portion CF1 is the same as a sectional shape of the intermediate portion M1. Specifically, the sheet-shaped portion 111a is in connection to the bottom wall portion 111. The sheet-shaped portion 112a is in connection to the side wall portion 112. The sheet-shaped portion 113a is in connection to the side wall portion 113. The sheet-shaped portion 121a is in connection to the bottom wall portion 121. The sheet-shaped portion 122a is in connection to the side wall portion 122. The sheet-shaped portion 123a is in connection to the side wall portion 123. The sheet-shaped portion 13a is in connection to the connecting wall portion 13.

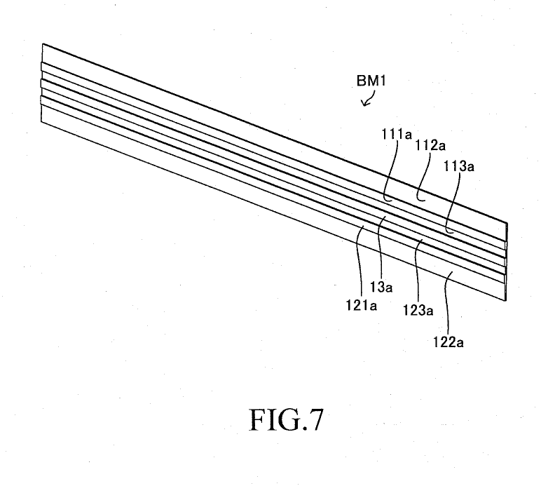

Now, a method of manufacturing the vehicle door impact beam 10 is described. First, as illustrated in FIG. 7, a metal material (for example, an aluminum alloy material) is extruded to manufacture a sheet-shaped member BM1 having a band-like shape (extrusion step). A sectional shape of the sheet-shaped member BM1, which is perpendicular to the longitudinal direction, is as illustrated in FIG. 6. Specifically, the sectional shape of the sheet-shaped member BM1, which is perpendicular to the longitudinal direction, is the same as a sectional shape of each of the front end portion F1 and the rear end portion R1, which is perpendicular to the longitudinal direction. More specifically, the sheet-shaped member BM1 includes the sheet-shaped portions 111a, 112a, 113a, 121a, 122a, 123a, and 13a. The sheet-shaped portions 111a and 121a correspond to first sheet-shaped portions of the present invention, and the sheet-shaped portions 112a, 113a, 122a, and 123a correspond to second sheet-shaped portions of the present invention. Specifically, a sheet thickness of each of the sheet-shaped portions 112a, 113a, 122a, and 123a is smaller than a sheet thickness of each of the sheet-shaped portions 111a and 121a. Further, each of the sheet-shaped portions 111a, 121a, 112a, 113a, 122a, and 123a is formed into a band-like shape. The sheet-shaped portions 112a and 113a are formed to extend along ends of the sheet-shaped portion 111a in the width direction. The sheet-shaped portions 122a and 123a are formed to extend along ends of the sheet-shaped portions 121a in the width direction.

Subsequently, by using a die quenching method (hot-pressing method), an intermediate portion of the sheet-shaped member BM1 in the longitudinal direction, which is being heated, is formed to have the sectional shape as illustrated in FIG. 5, which is perpendicular to the longitudinal direction. At the same time, the intermediate portion of the sheet-shaped member BM1 is quickly cooled to be quenched (press-working step). Specifically, the sheet-shaped member BM1 is pressed so that the sheet-shaped portions 111a and 121a of the sheet-shaped member BM1 face the outer panel OP of the door DR and the sheet-shaped portions 112a, 113a, 122a, and 123a extend from the ends of the sheet-shaped portion 111a and the ends of the sheet-shaped portion 121a in the width direction toward the inner panel IP. Then, the through hole is formed in the sheet-shaped portion 13a. In this manner, the vehicle door impact beam 10 is formed.

A bolt is inserted into the through hole from the right side (vehicle interior side) of the inner panel IP so that a distal end of the bolt is fastened to a nut. As a result, the vehicle door impact beam 10 is fixed to a left surface of the inner panel IP. Under a state in which the vehicle door impact beam 10 is fixed to the inner panel IP, both ends of the vehicle door impact beam 10 in the beam longitudinal direction are in abutment against the inner panel IP. However, the intermediate portion in the beam longitudinal direction and the inner panel IP are separated from each other.

As described above, each of the front end portion F1 and the rear end portion R1 of the vehicle door impact beam 10 has the sheet-like shape. Therefore, even when the internal space at the ends of the door DR is small, the vehicle door impact beam 10 can be directly mounted in the door DR without using brackets.

Further, the sheet-shaped member BM1 does not have a closed space. Therefore, an extruding speed can be increased to be higher than an extruding speed for related-art vehicle door impact beams having a cylindrical shape. Hence, a material can be more easily extruded through a die than in a case in which a cylindrical member such as the vehicle door impact beams described in Patent Literature 1 and Patent Literature 2 is manufactured. Therefore, a material having a higher strength than strengths of materials for the related art can be used. For related-art vehicle door impact beams, an aluminum alloy material having a tensile strength of about 400 MPa is adopted. On the other hand, for the vehicle door impact beam 10, an aluminum alloy material having a tensile strength of about 500 MPa can be adopted.

Further, in the vehicle door impact beam 10, the thickness of each of the bottom wall portion 111 of the first groove portion 11, the bottom wall portion 121 of the second groove portion 12, and the connecting wall portion 13, which have a large effect on a flexural rigidity, is set larger than the thickness of each of the side wall portions 112, 113, 122, and 123, which have a small effect on the flexural rigidity. In this manner, the flexural rigidity can be kept high, and the vehicle door impact beam 10 can be reduced in weight at the same time.

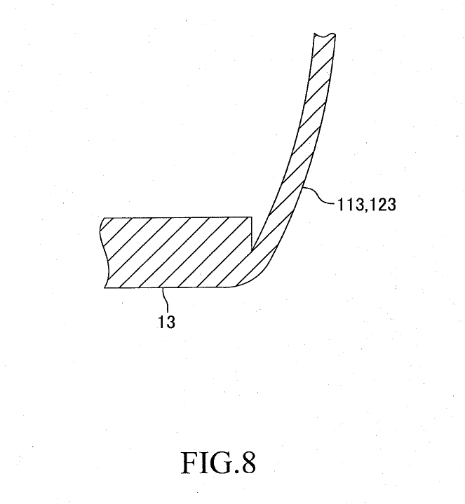

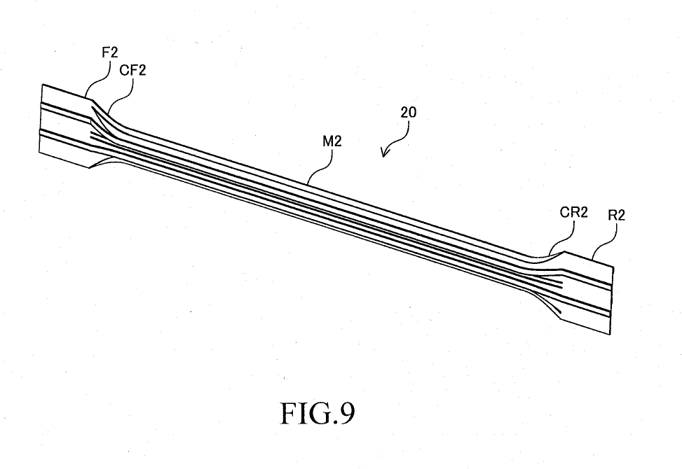

In the vehicle door impact beam 10 that is formed by pressing the sheet-shaped member BM1 illustrated in FIG. 7, as illustrated in FIG. 8, the vehicle door impact beam 10 is largely bent at a boundary portion between the connecting wall portion 13 and the side wall portion 113 or at a boundary portion between the connecting wall portion 13 and the side wall portion 123. Therefore, the boundary portions may have a slightly low strength. A vehicle door impact beam 20 that has been achieved to cope with the problem of the low strength is now described.

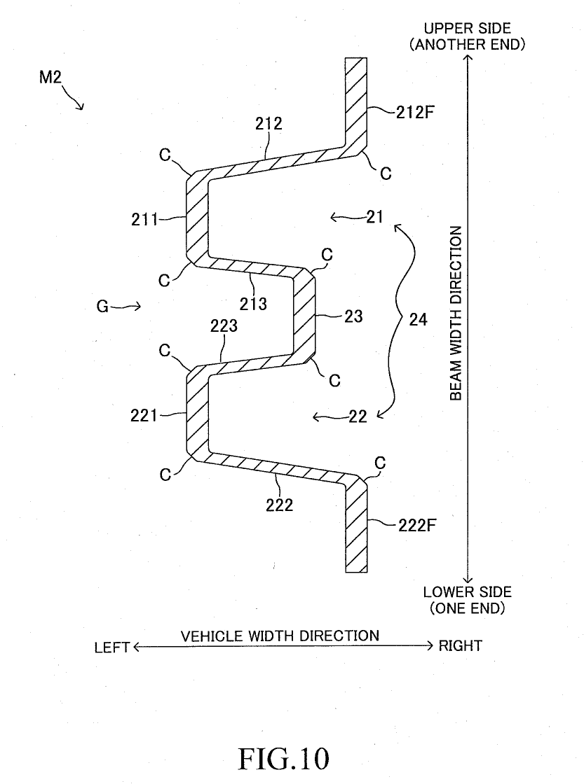

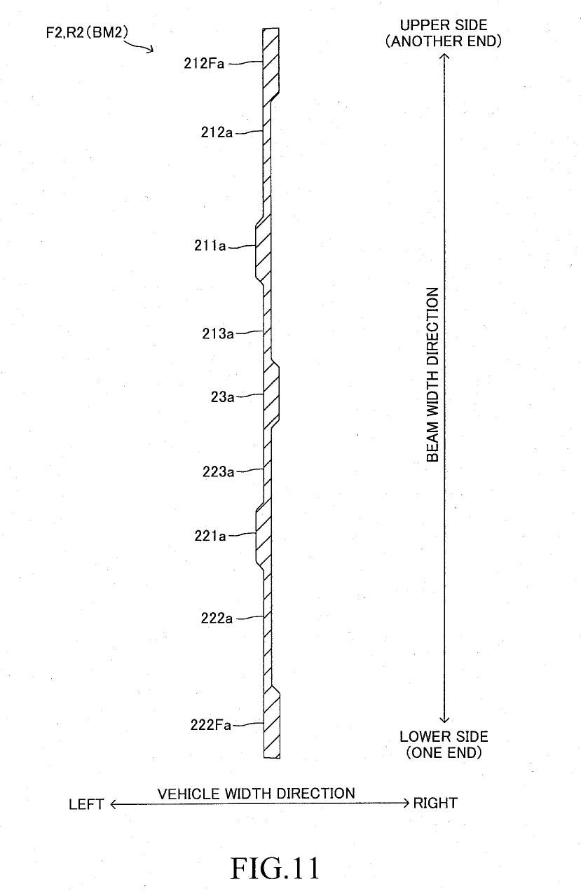

The vehicle door impact beam 20 includes, similarly to the vehicle door impact beam 10, an intermediate portion M2 in the longitudinal direction formed into a groove-like shape, and a front end portion F2 and a rear end portion R2 each formed into a flat sheet-like shape. A shape of the intermediate portion M2 of the vehicle door impact beam 20 is, as illustrated in FIG. 10, approximately the same as the shape of the intermediate portion M1 of the vehicle door impact beam 10. Specifically, the vehicle door impact beam 20 has a groove-shaped portion 24 including a first groove portion 21 and a second groove portion 22. The first groove portion 21 and the second groove portion 22 are in connection to each other through a connecting wall portion 23. In contrast to the vehicle door impact beam 10, however, a chamfered portion C is formed at each of upper ends and lower ends of a bottom wall portion 211, a bottom wall portion 221, and the connecting wall portion 23. Further, a sheet thickness of each of a flange portion 212F and a flange portion 222F is the same as a sheet thickness of each of the bottom wall portion 211, the bottom wall portion 221, and the connecting wall portion 23. The chamfered portions C are formed at a lower end of the flange portion 212F and an upper end of the flange portion 222F, respectively. Shapes of the front end portion F2 and the rear end portion R2 are as illustrated in FIG. 11. More specifically, the front end portion F2 and the rear end portion R2 each include sheet-shaped portions 211a, 212a, 213a, 212Fa, 221a, 222a, 223a, 222Fa, and 23a. The sheet-shaped portions 211a and 221a correspond to first sheet-shaped portions of the present invention, and the sheet-shaped portions 212a, 213a, 222a, and 223a correspond to second sheet-shaped portions of the present invention. Specifically, a sheet thickness of each of the sheet-shaped portions 212a, 213a, 222a, and 223a is smaller than a sheet thickness of each of the sheet-shaped portions 211a and 221a. Further, each of the sheet-shaped portions is formed into a band-like shape. The sheet-shaped portions 212a and 213a are formed to extend along ends of the sheet-shaped portion 211a in the width direction. Further, the sheet-shaped portions 222a and 223a are formed to extend along ends of the sheet-shaped portion 221a in the width direction. Further, the sheet-shaped portion 212Fa and the sheet-shaped portion 222Fa are formed at both ends of a sheet-shaped member BM2 in the width direction, respectively. A sheet thickness of each of the sheet-shaped portion 212Fa and the sheet-shaped portion 222Fa is the same as the sheet thickness of each of the sheet-shaped portions 211a and 221a.

One side surface (right surface) of the sheet-shaped portion 212a and one side surface (right surface) of the sheet-shaped portion 213a, which form part of one side surface (right surface) of the sheet-shaped member BM2, are in connection to one side surface of the sheet-shaped portion 211a, which forms part of one side surface (right surface) of the sheet-shaped member BM2. Specifically, the right surfaces of the sheet-shaped portions 211a, 212a, and 213a are located in the same plane. In other words, no level difference is formed on part of the right surface of the sheet-shaped member BM2, which is formed of the right surfaces of the sheet-shaped portions 211a, 212a, and 213a.

One side surface (right surface) of the sheet-shaped portion 222a and one side surface (right surface) of the sheet-shaped portion 223a, which form part of one side surface (right surface) of the sheet-shaped member BM2, are in connection to one side surface of the sheet-shaped portion 221a, which forms part of one side surface (right surface) of the sheet-shaped member BM2. Specifically, the right surfaces of the sheet-shaped portions 221a, 222a, and 223a are located in the same plane. In other words, no level difference is formed on part of the right surface of the sheet-shaped member BM2, which is formed of the right surfaces of the sheet-shaped portions 221a, 222a, and 223a.

Similarly to the above-mentioned configuration of the right surfaces of the sheet-shaped portions 211a, 212a, and 213a and the above-mentioned configuration of the right surfaces of the sheet-shaped portions 221a, 222a, and 223a, left surfaces of the sheet-shaped portions 23a, 213a, and 223a are located in the same plane. Further, left surfaces of the sheet-shaped portions 212a and 212Fa are located in the same plane. Further, left surfaces of the sheet-shaped portions 222a and 222Fa are located in the same plane.

The chamfered portions C are respectively formed in an upper left corner and a lower left corner of each of the sheet-shaped portions 211a and 221a. The chamfered portions C are respectively formed in an upper right corner and a lower right corner of the sheet-shaped portion 23a. Further, the chamfered portions C are respectively formed in a lower right corner of the sheet-shaped portion 212Fa and an upper right corner of the sheet-shaped portion 222Fa.

Now, a method of manufacturing the vehicle door impact beam 20 is described. First, a metal material (for example, an aluminum alloy material) is extruded to manufacture the sheet-shaped member BM2 having a band-like shape (extrusion step). A sectional shape of the sheet-shaped member BM2, which is perpendicular to the longitudinal direction, is as illustrated in FIG. 11.

Subsequently, by using a die quenching method (hot-pressing method), an intermediate portion of the sheet-shaped member BM2 in the longitudinal direction, which is being heated, is formed to have the sectional shape as illustrated in FIG. 10, which is perpendicular to the longitudinal direction. At the same time, the intermediate portion of the sheet-shaped member BM2 is quickly cooled to be quenched (press-working step). Specifically, the sheet-shaped member BM2 is pressed so that the sheet-shaped portions 211a and 221a of the sheet-shaped member BM2 face the outer panel OP of the door DR, the sheet-shaped portions 212a, 213a, 222a, and 223a extend from ends of the sheet-shaped portions 211a and 221a in the width direction toward the inner panel IP, and the sheet-shaped portions 212Fa and 222Fa face the inner panel IP of the door DR (see FIG. 13). Specifically, the sheet-shaped member BM2 is pressed so that the right surface of the sheet-shaped portion 211a and the right surfaces of the sheet-shaped portions 212a and 213a form an inner surface of the first groove portion 21. The sheet-shaped member BM2 is pressed so that the right surface of the sheet-shaped portion 221a and the right surfaces of the sheet-shaped portions 222a and 223a form an inner surface of the second groove portion 22. Then, the through hole is formed in the sheet-shaped portion 23a. In this manner, the vehicle door impact beam 20 is formed.

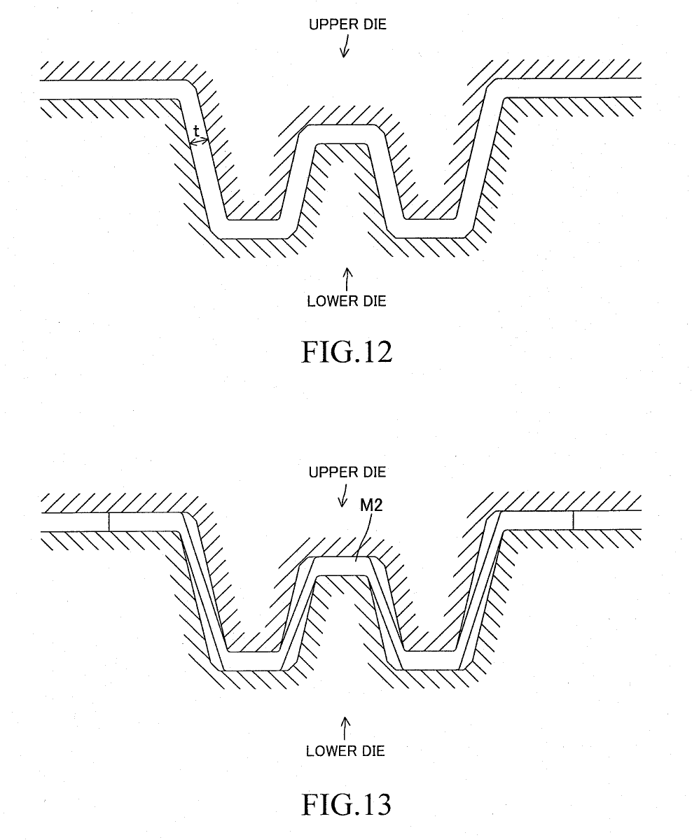

As illustrated in FIG. 12, in the above-mentioned press-working step, a die formed of an upper die and a lower die is used. When the die is in a closed state, a gap t between the upper die and the lower die (specifically, a portion configured to form the intermediate portion M2 of the vehicle door impact beam 20) is the same as the sheet thickness of, for example, the sheet-shaped portions 211a and 221a. Specifically, a die similar to a die that is used to form a vehicle door impact beam having the same sheet thickness for the bottom wall portions and the side wall surfaces is used. Therefore, as illustrated in FIG. 13, at the time of formation of the intermediate portion M2 of the vehicle door impact beam 20, the side wall portions 212, 213, 222, and 223 are not in contact with the die when the die is in the closed state.

As described above, the right surfaces of the sheet-shaped portions 211a, 212a, and 213a are located in the same plane. Therefore, a largely bent portion is not formed at a boundary between the bottom wall portion 211 and the side wall portion 212 and a boundary between the bottom wall portion 211 and the side wall portion 213. Further, the right surfaces of the sheet-shaped portions 221a, 222a, and 223a are located in the same plane. Therefore, a largely bent portion is not formed at a boundary between the bottom wall portion 221 and the side wall portion 222 and a boundary between the bottom wall portion 221 and the side wall portion 223. Further, a largely bent portion is not formed at other portions of the vehicle door impact beam 20 (a boundary between the connecting wall portion 23 and the side wall portion 213, a boundary between the connecting wall portion 23 and the side wall portion 223, a boundary between the side wall portion 212 and the flange portion 212F, and a boundary between the side wall portion 222 and the flange portion 222F). Thus, a strength of the vehicle door impact beam 20 can be increased to be higher than the strength of the vehicle door impact beam 10.

Further, as illustrated in FIG. 13, there is no portion that may be formed as an undercut. Therefore, a die having a complicated structure such as a sliding structure is not required. Further, as described above, the die that is used to form the vehicle door impact beam having the same thickness for the bottom wall portions and the side wall portions can be directly used.

When carrying out the present invention as the vehicle door impact beam, the present invention is not limited to the above-mentioned embodiment, and various modifications may be made without departing from the object of the present invention.

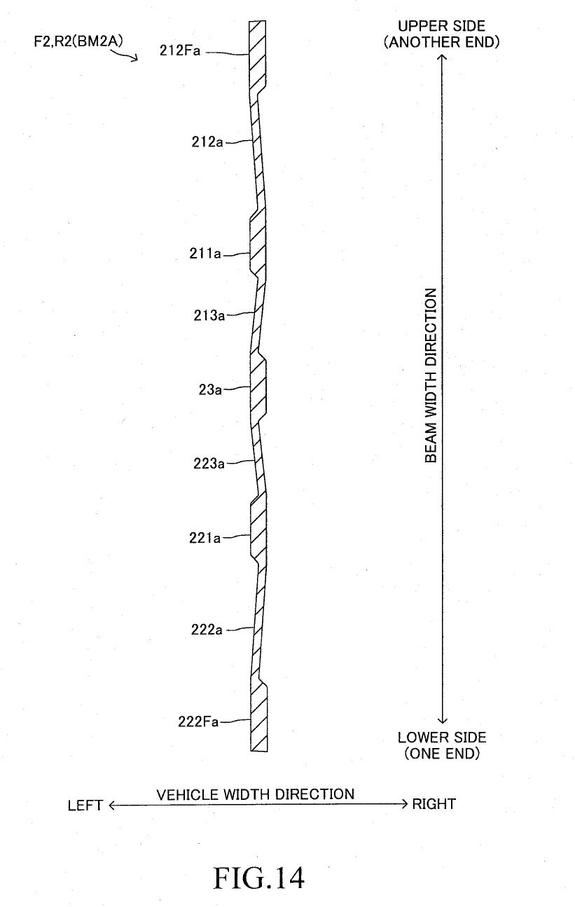

For example, the sectional shape of the sheet-shaped member BM2 is not limited to the shape of FIG. 11. For example, as illustrated in FIG. 14, a sheet-shaped member BM2A may be formed so that the right surfaces of the sheet-shaped portions 211a, 221a, 212Fa, and 222Fa are located in the same plane and the left surfaces of the sheet-shaped portions 211a, 221a, 212Fa, and 222Fa are located in the same plane. In this case, the sheet-shaped portions 212a, 213a, 222a, and 223a are inclined with respect to the width direction of the sheet-shaped member BM2A. The right surface of the sheet-shaped portion 212a is continuous with the right surface of the sheet-shaped portion 211a, whereas the left surface of the sheet-shaped portion 212a is continuous with the left surface of the sheet-shaped portion 212Fa. The right surface of the sheet-shaped portion 213a is continuous with the right surface of the sheet-shaped portion 211a, whereas the left surface of the sheet-shaped portion 213a is continuous with the left surface of the sheet-shaped portion 23a. The left surface of the sheet-shaped portion 223a is continuous with the left surface of the sheet-shaped portion 23a, whereas the right surface of the sheet-shaped portion 223a is continuous with the right surface of the sheet-shaped portion 221a. The right surface of the sheet-shaped portion 222a is continuous with the right surface of the sheet-shaped portion 221a, whereas the left surface of the sheet-shaped portion 222a is continuous with the left surface of the sheet-shaped portion 222Fa.

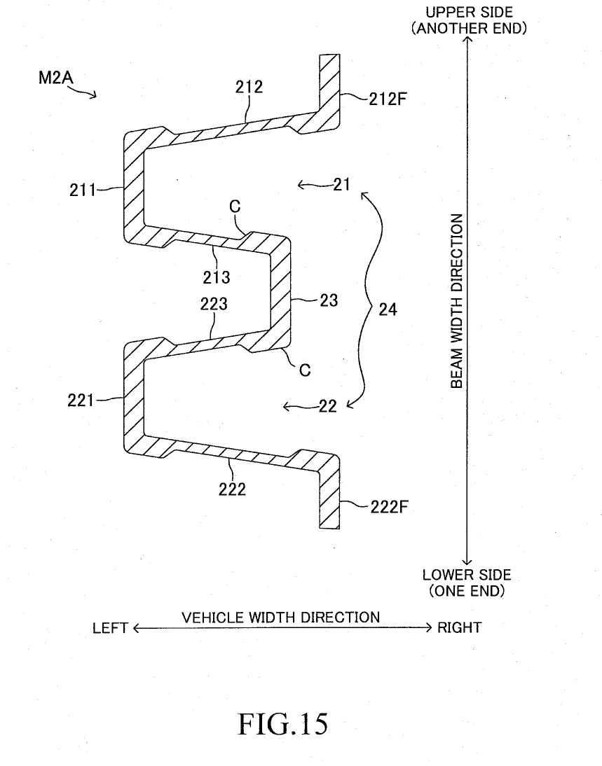

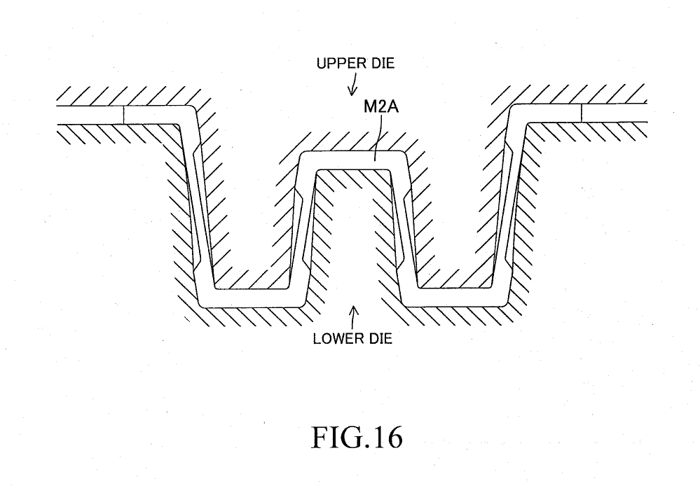

Further, the sectional shape of the intermediate portion M2 is not limited to the shape of FIG. 10. For example, an intermediate portion M2A as illustrated in FIG. 15 may be formed. As illustrated in FIG. 16, the intermediate portion M2A is formed by bending end portions of each of the sheet-shaped portions 211a, 221a, and 23a and an end portion of each of the sheet-shaped portions 212Fa and 222Fa. Even in this case, the die that is used to form the vehicle door impact beam having the same thickness for the bottom wall portions and the side wall portions can be directly used.

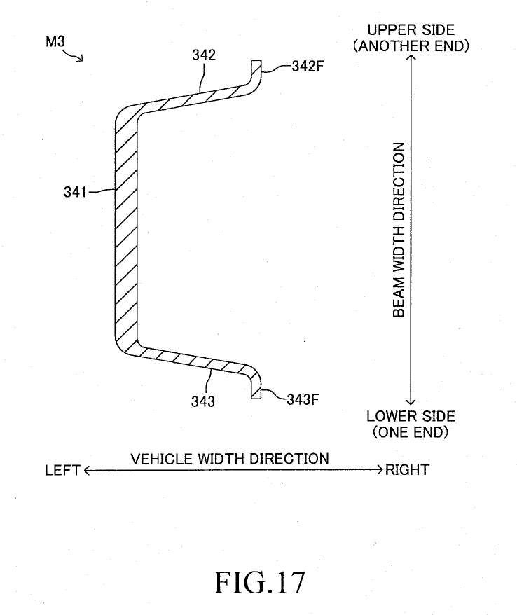

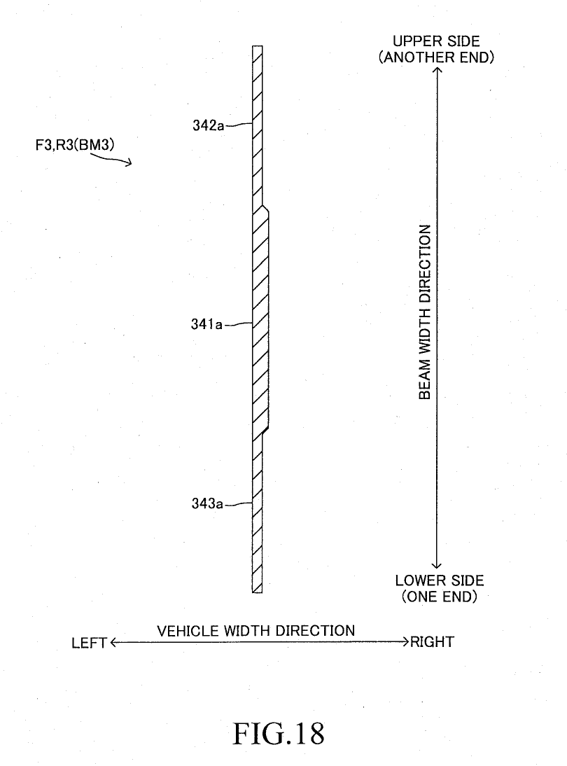

Further, for example, a vehicle door impact beam may be formed to have an intermediate portion M3 as illustrated in FIG. 17 and a front end portion F3 and a rear end portion R3 as illustrated in FIG. 18. Specifically, the intermediate portion M3 may have one groove portion being open toward the inner panel IP. Specifically, the intermediate portion M3 has a bottom wall portion 341, side wall portions 342 and 343, and flange portions 342F and 343F. Further, the front end portion F3 (rear end portion R3) has sheet-shaped portions 341a, 342a, and 343a. In this case, a sheet-shaped member BM3 having a sectional shape illustrated in FIG. 18 is required to be manufactured in advance by using the extrusion molding method, and the intermediate portion of the sheet-shaped member BM3 in the longitudinal direction is required to be then pressed so as to have the shape as illustrated in FIG. 17. The sheet-shaped portion 341a corresponds to the first sheet-shaped portion of the present invention, whereas the sheet-shaped portions 342a and 343a correspond to the second sheet-shaped portions of the present invention.

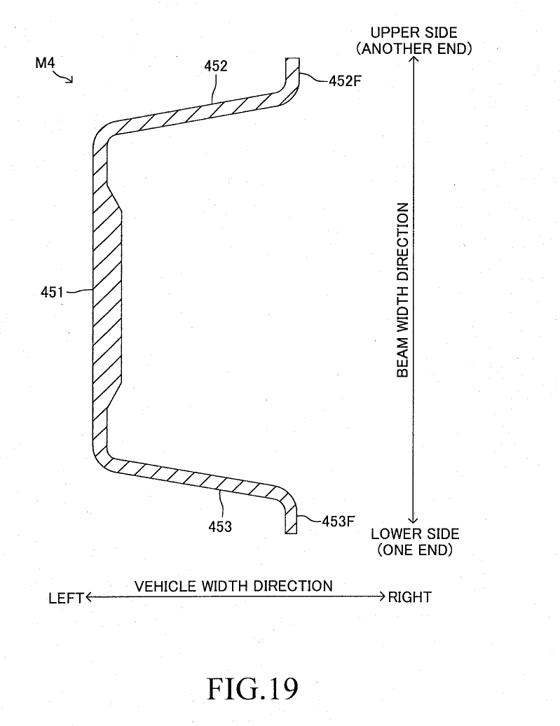

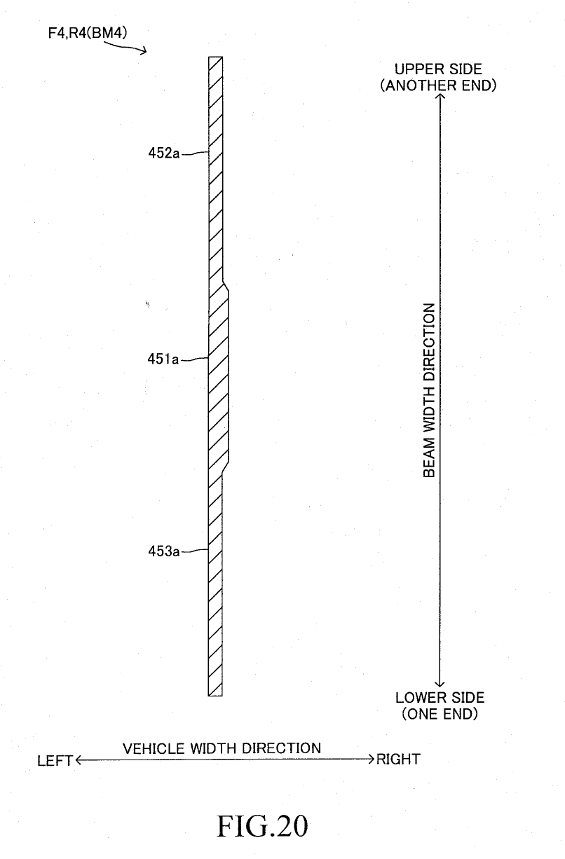

Further, a vehicle door impact beam may be formed to have an intermediate portion M4 as illustrated in FIG. 19 and a front end portion F4 and a rear end portion R4 as illustrated in FIG. 20. Specifically, the intermediate portion M4 has a bottom wall portion 451, side wall portions 452 and 453, and flange portions 452F and 453F. Further, the front end portion F4 (rear end portion R4) has sheet-shaped portions 451a, 452a, and 453a. In this case, a sheet-shaped member BM4 having a sectional shape illustrated in FIG. 20 is required to be manufactured in advance by using the extrusion molding method, and the intermediate portion of the sheet-shaped member BM4 in the longitudinal direction is required to be then pressed so as to have the shape as illustrated in FIG. 19. The sheet-shaped portion 451a corresponds to the first sheet-shaped portion of the present invention, whereas the sheet-shaped portions 452a and 453a correspond to the second sheet-shaped portions of the present invention.

### Second Embodiment

Now, a center pillar 50 according to a second embodiment of the present invention is described. The center pillar 50 is provided in a side surface portion of a vehicle so as to extend in the vehicle height direction. The center pillar 50 is arranged in a central portion of an opening (doorway) formed in the side surface portion of the vehicle in a vehicle fore-and-aft direction. Although the center pillar 50 provided in a left side surface portion of the vehicle is described in the second embodiment, the present invention is also applicable to a center pillar provided in a right side surface portion of the vehicle.

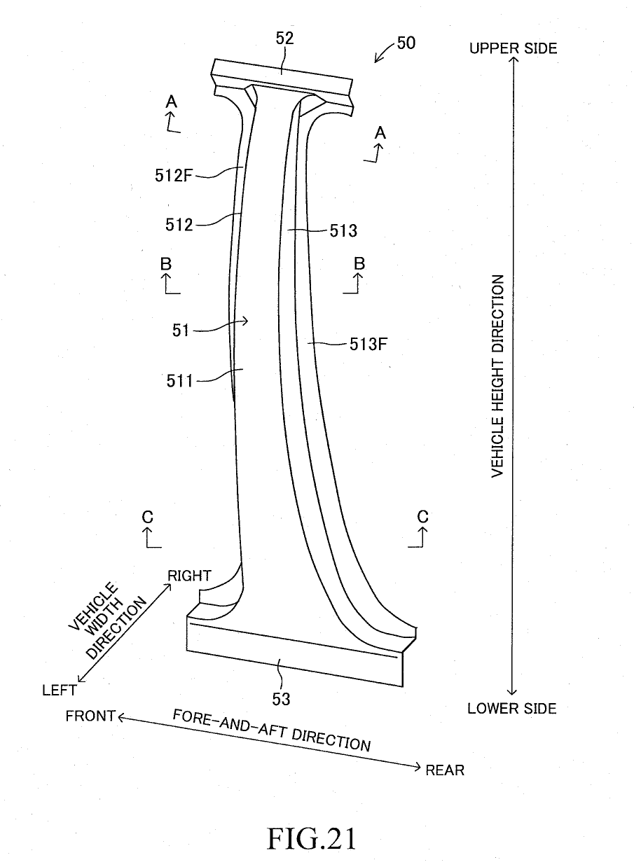

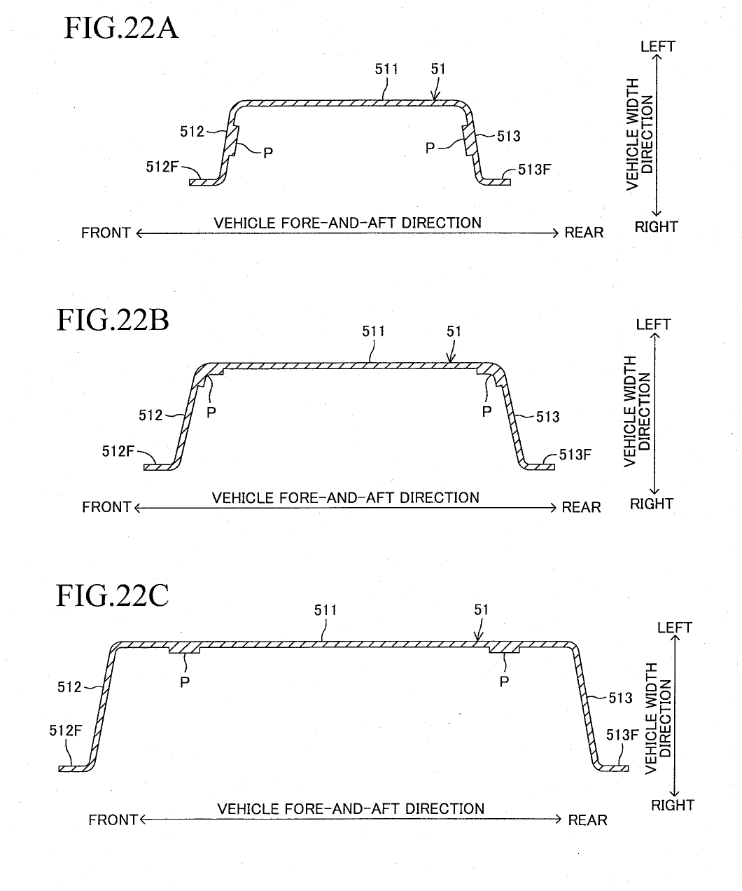

As illustrated in FIG. 21, FIG. 22A, FIG. 22B, and FIG. 22C, the center pillar 50 has a groove-shaped portion 51 that extends in the vehicle height direction and is open toward the right side (vehicle interior side). Specifically, the groove-shaped portion 51 has a bottom wall portion 511, a side wall portion 512, and a side wall portion 513. The bottom wall portion 511 is formed into a sheet-like shape approximately perpendicular to the vehicle width direction. More precisely, the bottom wall portion 511 is gently curved so that an upper end portion of the bottom wall portion 511 is located slightly on the right side with respect to a lower end portion thereof. Further, a dimension of the bottom wall portion 511 in the vehicle fore-and-aft direction is gradually increased in a downward direction from the upper end portion of the bottom wall portion 511. A dimension of the lower end portion (portion corresponding to about one-fourth of a total length) of the bottom wall portion 511 in the vehicle fore-and-aft direction is rapidly (exponentially) increased.

The side wall portion 512 is formed to extend to the right side from a front end portion of the bottom wall portion 511. Further, the side wall portion 513 is formed to extend to the right side from a rear end portion of the bottom wall portion 511. A flange portion 512F is formed on the side wall portion 512, and a flange portion 513F is formed on the side wall portion 513. The flange portion 512F is formed to extend forward from a right end portion of the side wall portion 512. The flange portion 513F is formed to extend rearward from a right end portion of the side wall portion 513.

An upper connecting portion 52 to be connected to a member (roof side rail) that constructs a skeleton of a roof of the vehicle is formed at an upper end of the groove-shaped portion 51. The upper connecting portion 52 is formed into a sheet-like shape to extend in the vehicle fore-and-aft direction so as to be approximately in parallel to the upper end portion of the bottom wall portion 511. A lower connecting portion 53 to be connected to a member (side sill) that constructs a lower edge portion of the doorway of the vehicle is formed at a lower end of the groove-shaped portion 51. The lower connecting portion 53 is formed into a sheet-like shape to extend in the vehicle fore-and-aft direction so as to be approximately in parallel to the lower end portion of the bottom wall portion 511.

As illustrated in FIG. 22A, FIG. 22B, and FIG. 22C, protruding portions P and P extending in parallel to a longitudinal direction of the groove-shaped portion 51 are formed on an inner surface of the groove-shaped portion 51. As illustrated in FIG. 22A, in the vicinity of the upper end of the groove-shaped portion 51, the protruding portions P and P are located on an inner surface of the side wall portion 512 and an inner surface of the side wall portion 513, respectively. As illustrated in FIG. 22B, in the vicinity of a central portion of the groove-shaped portion 51 in the longitudinal direction, the protruding portions P and P are located at a boundary portion between the bottom wall portion 511 and the side wall portion 512 and a boundary portion between the bottom wall portion 511 and the side wall portion 513, respectively. Further, as illustrated in FIG. 22C, in the vicinity of the lower end of the groove-shaped portion 51, the protruding portions P and P are located on an inner surface of the bottom wall portion 511.

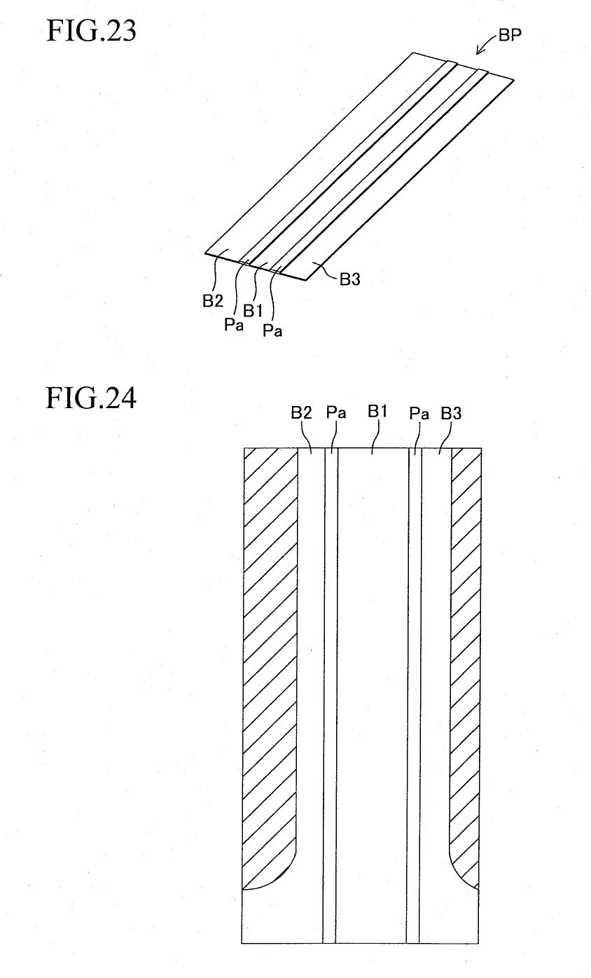

Now, a method of manufacturing the center pillar 50 is described. Similarly to the vehicle door impact beams 10 and 20, the center pillar 50 is formed by pressing a sheet-shaped member manufacture by using the extrusion molding method. Specifically, first, as illustrated in FIG. 23, a metal material (for example, an aluminum alloy material) is extruded to manufacture a sheet-shaped member BP having a band-like shape (extrusion step). An extrusion direction for the sheet-shaped member BP corresponds to the longitudinal direction of the center pillar 50 (vehicle height direction). The sheet-shaped member BP has sheet-shaped portions B1, B2, and B3 and a pair of sheet-shaped portions Pa and Pa. The sheet-shaped portions Pa and Pa correspond to the first sheet-shaped portions of the present invention, whereas the sheet-shaped portions B1, B2, and B3 correspond to the second sheet-shaped portions of the present invention. Specifically, each of sheet thicknesses of the sheet-shaped portions B1, B2, and B3 is smaller than a sheet thickness of each of the sheet-shaped portions Pa and Pa. Further, each of the sheet-shaped portions B1, B2, and B3 and the pair of sheet-shaped portions Pa and Pa is formed into a band-like shape. The sheet-shaped portions B1, B2, and B3 are separated from each other in a width direction of the sheet-shaped member BP (direction perpendicular to the extrusion direction and a sheet thickness direction). One of the sheet-shaped portions Pa is formed between the sheet-shaped portion B1 and the sheet-shaped portion B2, whereas another of the sheet-shaped portions Pa is formed between the sheet-shaped portion B1 and the sheet-shaped portion B3. A dimension of each of the sheet-shaped portions Pa and Pa in the width direction is smaller than each of dimensions of the sheet-shaped portions B1, B2, and B3 in the width direction.

Subsequently, part of the sheet-shaped portion B2 and part of the sheet-shaped portion B3 of the sheet-shaped member BP (corresponding to portions from an intermediate portion to an upper end of the center pillar 50 in the longitudinal direction (hatched portions in FIG. 24)) are trimmed away (trimming step).

Subsequently, by using the die quenching method (hot-pressing method), the sheet-shaped member BP, which is being heated, is formed to have the sectional shape as illustrated in FIG. 22A, FIG. 22B, and FIG. 22C, which is perpendicular to the longitudinal direction. At the same time, the sheet-shaped member BP is quickly cooled to be quenched (press-working step). Specifically, the groove-shaped portion 51 is formed in the following manner. In the intermediate portion of the sheet-shaped member BP in the longitudinal direction, the sheet-shaped member BP is bent along the longitudinal direction of the sheet-shaped portions Pa and Pa at an intermediate position on each of the sheet-shaped portions Pa and Pa in the width direction. In one end portion (upper end portion) of the sheet-shaped member BP in the longitudinal direction, the sheet-shaped member BP is bent at positions on the sheet-shaped portion B1, which are located on a slightly inner side of the sheet-shaped portions Pa and Pa. In another end portion (lower end portion) of the sheet-shaped portion BP in the longitudinal direction, the sheet-shaped member BP is bent at an end of the sheet-shaped portion B2 and an end of the sheet-shaped portion B3 in the width direction, which are located on an outer side of the sheet-shaped portions Pa and Pa. In this manner, the groove-shaped portion 51 is formed. Specifically, the above-mentioned bent portions correspond to ridge lines of the groove portion 51. Further, the sheet-shaped portions Pa and Pa correspond to the protruding portions P and P.

With the center pillar 50 configured as described above, the same effects as those obtained in the first embodiment are obtained. In particular, in the center pillar 50, a sheet thickness at the boundary portion between the bottom wall portion 511 and the side wall portion 512 and at the boundary portion between the bottom wall portion 511 and the side wall portion 513 in the intermediate portion in the longitudinal direction, which have a large effect on the flexural rigidity, is increased to be larger than thicknesses of other portions that have a small effect on the flexural rigidity. In this manner, the flexural rigidity can be kept high, and the center pillar 50 can be reduced in weight at the same time. Further, the center pillar 50 is formed integrally. Therefore, as compared to related-art center pillars each having an increased rigidity by combining a plurality of components, not only the number of components but also the number of assembly steps can be reduced.

When carrying out the present invention as the center pillar, the present invention is not limited to the above-mentioned embodiment, and various modifications may be made without departing from the object of the present invention.

In the upper end portion and the lower end portion of the center pillar 50, the protruding portions P and P are not located on the ridge lines of the groove-shaped portion 51. Therefore, in the upper end portion and the lower end portion, the protruding portions P and P do not much contribute to improvement of the rigidity of the center pillar 50. Therefore, in the press-working step, the sheet-shaped portions Pa and Pa may be compressed in the upper end portion and the lower end portion of the center pillar 50.

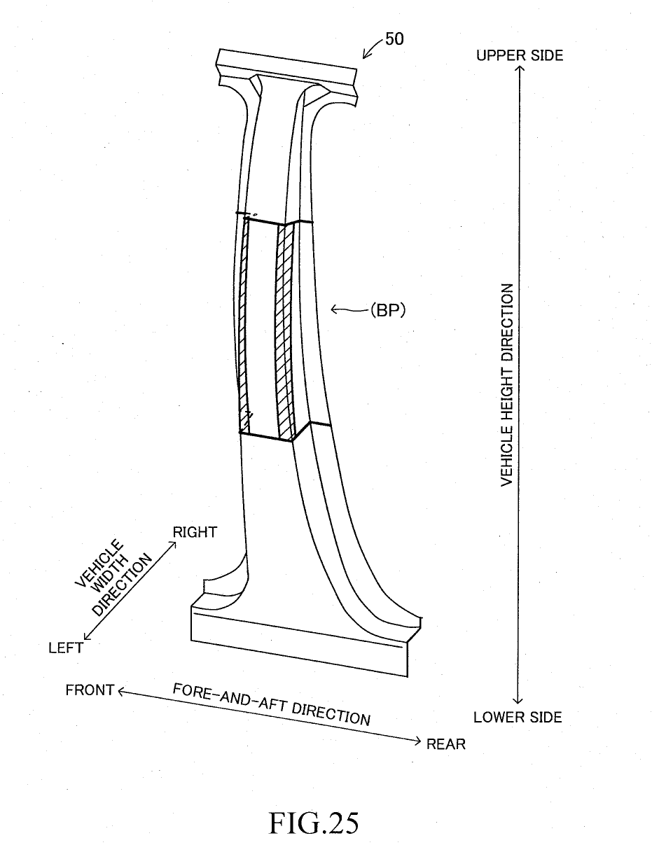

Further, as illustrated in FIG. 25, only the intermediate portion of the center pillar 50 in the longitudinal direction may be formed of the sheet-shaped member BP, and the upper end portion and the lower end portion may be formed of sheet-shaped members each having a constant sheet thickness, respectively. In this case, a member (tailored blank member) obtained by joining the sheet-shaped member BP and the sheet-shaped members having the constant sheet thickness is required to be pressed.

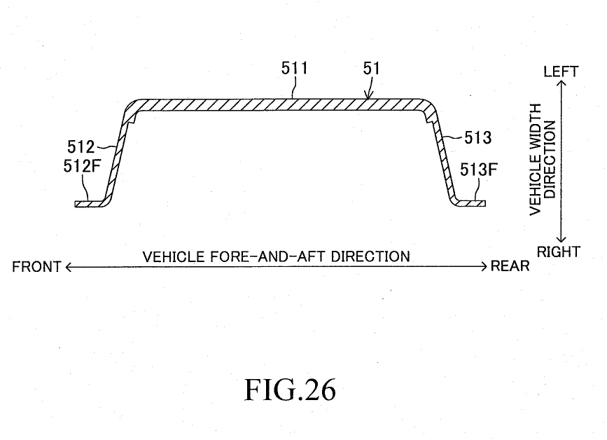

Further, as illustrated in FIG. 26, an overall sheet thickness of the bottom wall portions 511 and an overall sheet thickness of portions corresponding to the ridge lines of the groove-shaped portion 51 may be increased.

Although the die quenching method (hot-pressing method) is as the press-working step, for example, a cold-pressing method or a warm-pressing method may be used.

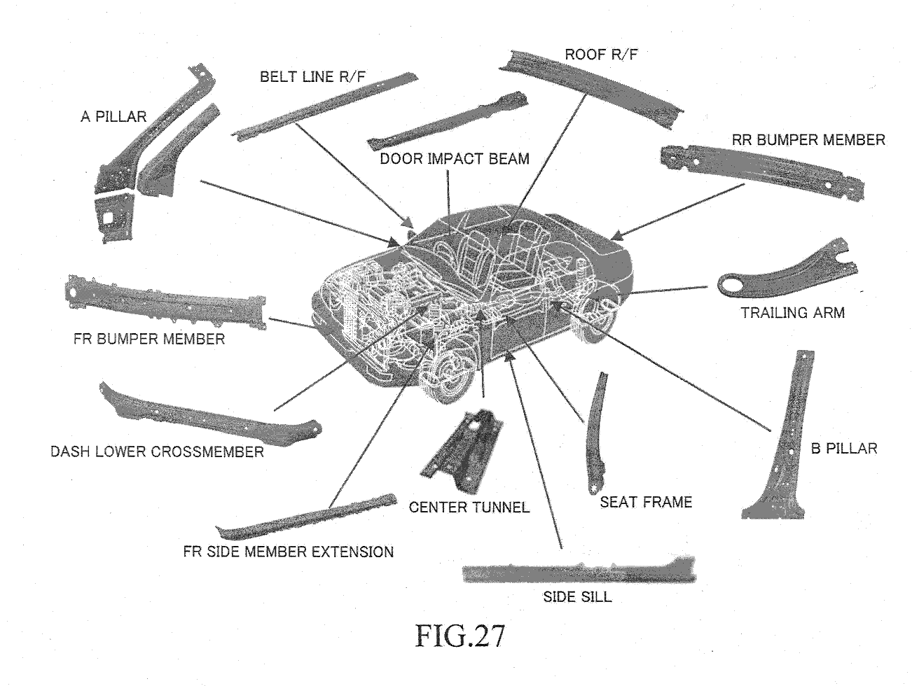

Further, the present invention is also applicable to a vehicle skeleton member, which is different from the vehicle skeleton members in the embodiments described above. For example, as illustrated in FIG. 27, the present invention is applicable to, for example, a front side member or a roof reinforcement. In this case, a sheet thickness of a surface perpendicular to a direction of an external force exerted on the member or a sheet thickness of a bent portion is required to be increased to be larger than sheet thicknesses of other portions.

### REFERENCE SIGNS LIST

10, 20 . . . vehicle door impact beam, 50 . . . center pillar, 11, 21 . . . first groove portion, 111, 121, 211, 221, 311, 411, 511 . . . bottom wall portion, 111a, 112a, 113a, 121a, 122a, 123a, 211a, 212a, 213a, 221a, 222a, 223a, 311a, 312a, 313a, 411a, 412a, 413a, B1, B2, B3, Pa . . . sheet-shaped portion, 112, 113, 122, 123, 212, 213, 222, 223, 312, 313, 412, 413, 512, 513 . . . side wall portion, 12, 22 . . . second groove portion, 13, 23 . . . connecting wall portion, 14, 24, 51 . . . groove-shaped portion, BM1, BM2, BM3, BM4, BP . . . sheet-shaped member, DR . . . door, F1 . . . front end portion, G . . . groove portion, IP . . . inner panel, M1, M2, M2A, M3, M4 . . . intermediate portion, OP . . . outer panel, P . . . protruding portion, R1 . . . rear end portion, V . . . vehicle

1. A method of manufacturing a vehicle skeleton member, the skeleton member including one or more groove-shaped portions extending in a predetermined direction,
the method comprising:
an extrusion step of manufacturing, by using an extrusion molding method, a sheet-shaped member including one or more first sheet-shaped portions each having a band-like shape and extending in the predetermined direction, and second sheet-shaped portions each having a band-like shape and extending in the predetermined direction along end portions of the first sheet-shaped portion in a width direction of the sheet-shaped member, and each having a sheet thickness smaller than a sheet thickness of the first sheet-shaped portion; and
a press-working step of pressing the sheet-shaped member by using a die quenching method so that at least part of a bottom wall portion of the groove-shaped portion is formed of the first sheet-shaped portion, and side wall portions of the groove-shaped portion are formed of the second sheet-shaped portions, respectively.

2. A method of manufacturing a vehicle skeleton member according to claim 1,
wherein one side surfaces of two of the second sheet-shaped members respectively located on both sides of the first sheet-shaped portion, which form part of one side surface of the sheet-shaped member, are continuous with one side surface of the first sheet-shaped member, which forms part of the one side surface of the sheet-shaped member, and
wherein, in the press-working step, the sheet-shaped member is pressed so that the one side surface of the first sheet-shaped portion and the one side surfaces of the two second sheet-shaped portions form an inner surface of the groove-shaped portion.

3. A method of manufacturing a vehicle skeleton member according to claim 2,
wherein each end portion of the sheet-shaped member in the width direction of the sheet-shaped member is formed of the first sheet-shaped portion,
wherein, in the press-working step, the sheet-shaped member is processed with use of a die formed of an upper die and a lower die, and
wherein a gap between the upper die and the lower die when a die is in a closed state is set equal to the sheet thickness of the first sheet-shaped portion.

4. A method of manufacturing a vehicle skeleton member according to claim 1, wherein, in the press-working step, the sheet-shaped member is pressed so that at least a boundary portion between the bottom wall portion and each of the side wall portions of the groove-shaped portion is formed of the first sheet-shaped portion and the side wall portions of the groove-shaped portion are formed of the second sheet-shaped portions, respectively.

5. (canceled)
